(19) United States
(12) Patent Application Publication
(10) Pub. No.: US 2014/0044978 A1
(43) Pub. Date: Feb. 13, 2014

(54) MULTIPLE LAYER GLAZING BILAYER COMPRISING CESIUM TUNGSTEN OXIDE

(71) Applicant: Solutia, Inc., St. Louis, MO (US)

(72) Inventors: Stephen Vincent Haldeman, Hampden, MA (US); William Keith Fisher, Suffield, CT (US)

(73) Assignee: Solutia, Inc., St. Louis, MO (US)

(21) Appl. No.: 14/057,625

(22) Filed: Oct. 18, 2013

Related U.S. Application Data
(63) Continuation of application No. 11/381,341, filed on May 2, 2006, now abandoned.

(51) Int. Cl. B32B 17/10

(52) U.S. Cl. CPC B32B 17/10449
USPC 428/432

(57) ABSTRACT

The present invention involves bilayers that include cesium tungsten oxide as an infrared absorbing agent. Cesium tungsten oxide can be incorporated into one or more layers of a bilayer. Bilayers of the present invention incorporating cesium tungsten oxide are effective at blocking infrared radiation and, surprisingly, the cesium tungsten oxide agents do not degrade unacceptably over time.

### CROSS-REFERENCE TO RELATED APPLICATION

This application is a continuation of U.S. patent application Ser. No. 11/381,341, filed on May 2, 2006, the disclosure of which is incorporated herein by reference in its entirety.

### FIELD OF THE INVENTION

The present invention is in the field of multiple layer glazing panels, and, specifically, the present invention is in the field of multiple layer glazing panels that have a single rigid substrate, such as glass or rigid plastic.

### BACKGROUND

Safety glass is a multiple layer glazing construct that typically employs a polymeric interlayer disposed between two layers of glass. Conventionally, safety glass of this type has been manufactured by placing a polymer sheet between two layers of glass and laminating the three layers by applying heat and pressure to produce a finished, multiple layer glass panel. The resulting glazing panel resists penetration of an object because the polymer sheet adheres strongly to the glass but remains flexible and energy absorbent.

Many variations on this theme have been reported. For example, the interlayer can be a single polymer sheet, or it can comprise multiple polymer sheets. In addition to polymer sheets, other functional layers can be included as part of an interlayer, including, for example, a polymer film that improves one or more characteristics of the finished product.

A safety glazing panel that uses only one rigid substrate, for example, a pane of glass or a pane of rigid plastic, is known in the art as a “bilayer.” In order to provide optimal optical clarity, a bilayer typically is formed with an interlayer, as described above, disposed between a rigid substrate and a relatively stiff polymer film. The polymer film provides the necessary stiffness to maintain a relatively smooth surface, which allows for optical clarity that would not be possible with only a polymer sheet.

One type of bilayer is formed by laminating a polymer sheet between a glass panel and a thin polyester film. Such a construct is suitable for applications, for example, in which a full two pane safety panel is either not desired or not practical. Bilayers can be used, for example, in the side windows of vehicles, where the full thickness of a two pane glass safety panel is generally undesirable.

Bilayers are frequently used in applications where reducing or eliminating the transmission of some wavelengths of light is desirable. For example, it is often desirable to reduce the amount of infrared, and specifically near infrared, radiation that passes through a bilayer. Conventional infrared absorbing agents, however, can be problematic when used in a bilayer because the outside polymer films of a bilayer can allow the ingress of moisture into the polymer sheet, which results in an increase in moisture in the polymer sheet and, potentially, the moisture-induced degradation of any infrared absorbing agents disposed therein.

Accordingly, further improved bilayer multiple layer glazing panels having infrared absorbing agents and methods for making those panels are needed in the art.

### SUMMARY OF THE INVENTION

The present invention involves bilayers that include cesium tungsten oxide as an infrared absorbing agent. Cesium tungsten oxide can be incorporated into one or more layers of a bilayer. Bilayers of the present invention incorporating cesium tungsten oxide are effective at blocking infrared radiation and, surprisingly, the cesium tungsten oxide agents do not degrade unacceptably over time.

### BRIEF DESCRIPTION OF THE DRAWINGS

FIG. 1 represents a schematic cross sectional view of various bilayer embodiments of the present invention.

FIG. 2 represents a schematic cross sectional view of various bilayer embodiments of the present invention.

FIG. 3 represents a schematic cross sectional view of various bilayer embodiments of the present invention.

### DETAILED DESCRIPTION

The present invention relates to an improved glazing bilayer. As used herein, a “bilayer” is a multiple layer glazing construct having a rigid substrate and a polymer film between which is disposed a polymer stack, wherein the polymer stack can comprise a single polymer sheet or a polymer sheet and one or more additional polymeric layers. The polymer stack is equivalent to a multiple layer interlayer in standard safety glass for which a single polymer sheet or a single polymer sheet and one or more additional polymeric layers have been combined to form the interlayer.

Bilayers of the present invention incorporate cesium tungsten oxide as an infrared absorbing agent. Cesium tungsten oxide can be dispersed in or on any one or more layers of a bilayer. In various embodiments, cesium tungsten oxide is dispersed within or on a polymer sheet, a polymer film, a layer of glass or rigid plastic substrate, or more than one of these layers. In various embodiments, cesium tungsten oxide is dispersed within a polymer sheet layer. Cesium tungsten oxide can be mixed directly into or disposed directly on any of the above-mentioned layers by any suitable method as is known in the art, for example, but not limited to addition during manufacture of an individual layer or dipping, spraying, or other topical treatment after manufacture.

Cesium tungsten oxide pigments of the present invention include any known cesium tungsten oxide pigments, and, in particular, those disclosed in U.S. Patent Application 20060008640A1. In various embodiments, cesium tungsten oxide having the mole ratio Cs_{0.33}WO₃ is used.

In various embodiments, the cesium tungsten oxide pigment is incorporated directly into the bulk of a polymer prior to formation of a polymeric layer. In these embodiments, cesium tungsten oxide pigment can be incorporated into the polymer so as to provide a polymer sheet or polymer film having a weight percentage amount of cesium tungsten oxide pigment of less than 1.0%, 0.8%, 0.6%, or 0.4%, or 0.01% to 1.0%, 0.05% to 0.5%, or 0.1% to 0.3%. In a preferred embodiment, cesium tungsten oxide pigment is incorporated into the bulk of a polymer sheet. In various embodiments, more than one type of cesium tungsten oxide pigment is included in a single or in multiple polymeric layers.

In general, cesium tungsten oxide will be incorporated into and/or disposed on a polymeric layer in an amount sufficient to achieve the desired infrared absorption effect. As will be appreciated by those of skill in the art, this amount will vary, depending on the other components and pigments. In various embodiments, a single polymeric layer will have sufficient cesium tungsten oxide pigment to prevent the transmission though the layer of at least 40%, 60%, 80%, 95%, or 99% of infrared radiation in the 800 nanometer to 1,000 nanometer range.

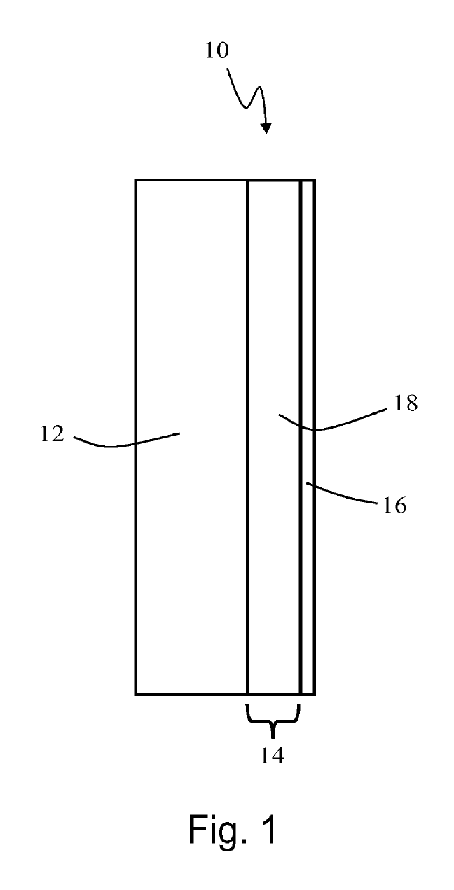

As shown in FIG. 1 generally at 10, in various embodiments a bilayer comprises a rigid substrate 12 and a polymer film 16 between which is disposed a polymer stack 14. For the embodiments shown in FIG. 1, the polymer stack consists of a single polymer sheet 18, but, as mentioned above, multiple layer polymer stacks are within the scope of a bilayer of the present invention.

As will be described in greater detail below, a polymer sheet 18 can comprise any suitable polymer, and, in preferred embodiments, the polymer sheet 18 comprises poly(vinyl butyral). As will also be described in detail below, the polymer film 16 can be any suitable polymer film, and, in preferred embodiments, the polymer film comprises poly(ethylene terephthalate). The rigid substrate 12 can be glass, rigid plastic, or any other rigid substrate conventionally used in glazing panels.

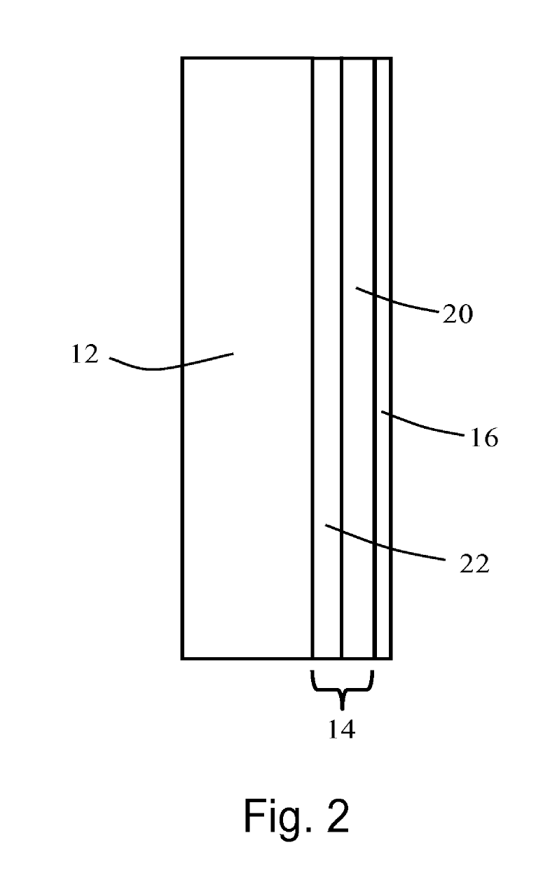

FIG. 2 shows other embodiments, in which the polymer stack comprises more than a single polymer sheet. As shown, a first polymer sheet 20 and a second polymer sheet have been combined to form the polymer stack, which is disposed between the rigid substrate 12 and the polymer film 16. Of course, embodiments in which three or more polymer sheets are combined to form the polymer stack are within the scope of the present invention. In embodiments with more than one polymer sheet in the polymer stack, as shown in FIG. 2, one or more of the polymer sheets can comprise cesium tungsten oxide, as described above. Further, the two or more polymer sheets in a polymer stack can be the same or different in any other respect. For example, in some embodiments two different types of polymer sheets are used, and in others, two polymer sheets having the same polymeric content are used, but each polymer sheet differs in the type and amount of additional agents that are included.

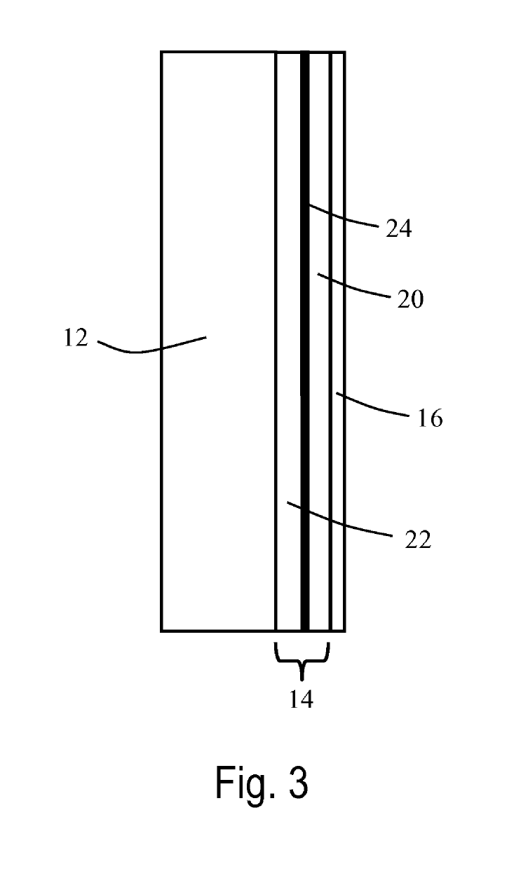

FIG. 3 shows yet further embodiments in which the polymer stack, in additional to two polymer sheets, also includes a functional performance polymer film. As shown, the polymer stack 14 comprises a first polymer sheet 20 and a second polymer sheet 22 with a second polymer film 24 disposed therebetween. In these embodiments, the second polymer film 24 can be the same or different from the polymer film 16, and, as above for the embodiments shown in FIG. 2, the two polymer sheets can be the same or different.

Embodiments such as those shown in FIGS. 2 and 3 provide a means through which various agents and performance enhancing layers can be included within a polymer stack to achieve results that would be difficult or impossible with a single polymer sheet.

Further included in the scope of the present invention are variations on the polymer stacks that are explicitly shown and described herein. For example, further polymer film layers and polymer sheet layers can be added to the polymer stack in many arrangements to produce a bilayer within the scope of the present invention.

Further included within the scope of the present invention are polymer stacks produced through extrusion coating or coextrusion processes. For example, the polymer stack shown in FIG. 2 can be formed by coextruding two polymers to form the two sheets shown, in addition to a conventional lamination procedure.

### Polymer Film

As used herein, a “polymer film” means a relatively thin and rigid polymer layer that functions as a performance enhancing layer within a polymer stack or as the outside layer in a bilayer, as shown as element 16 in the Figures. Polymer films differ from polymer sheets, as used herein, in that polymer films do not themselves provide the necessary impact resistance and glass retention properties to a multiple layer glazing structure, but rather provide performance improvements, such as infrared absorption character. Poly(ethylene terephthalate) is most commonly used as a polymer film.

Polymer films used in the present invention can be any suitable film that is sufficiently rigid to provide a relatively flat, stable surface, for example those polymer films conventionally used as a performance enhancing layer in multiple layer glass panels. The polymer film is preferably optically transparent (i.e. objects adjacent one side of the layer can be comfortably seen by the eye of a particular observer looking through the layer from the other side), and usually has a greater, in some embodiments 30 significantly greater, tensile modulus regardless of composition than that of the adjacent polymer sheet. In various embodiments, the polymer film comprises a thermoplastic material. Among thermoplastic materials having suitable properties are nylons, polyurethanes, acrylics, polycarbonates, polyolefins such as polypropylene, cellulose acetates and triacetates, vinyl chloride polymers and copolymers, and the like. In various embodiments, the polymer film comprises materials such as re-stretched thermoplastic films having the noted properties, for example, polyesters. In various embodiments, the polymer film comprises or consists of poly(ethylene terephthalate), and, in various embodiments, the poly(ethylene terephthalate) has been biaxially stretched to improve strength and/or has been heat stabilized to provide low shrinkage characteristics when subjected to elevated temperatures (e.g. less than 2% shrinkage in both directions after 30 minutes at 150° C.).

In various embodiments, a polymer film within a polymer stack can have a thickness of 0.012 millimeters to 0.26 millimeters, 0.025 millimeters to 0.11 millimeters, or 0.04 millimeters to 0.06 millimeters. In various embodiments, a polymer film that is used as the outside polymer film (element 16 in the Figures) can have a thickness of 0.1 millimeters to 0.26 millimeters, 0.12 millimeters to 0.22 millimeters, or 0.16 millimeters to 0.20 millimeters. The polymer film can optionally be surface treated or coated with a functional performance layer to improve one or more properties, such as adhesion or infrared radiation reflection. These functional performance layers include, for example, a multi-layer stack for reflecting infra-red solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example, two) sequentially deposited, optically cooperating dielectric layers. As is also known (see, for example, U.S. Pat. Nos. 4,017,661 and 4,786,783), the metal layer(s) may optionally be electrically resistance heated for defrosting or defogging of any associated glass layers. Various coating and surface treatment techniques for poly(ethylene terephthalate) films and other polymer films that can be used with the present invention are disclosed in published European Application No. 0157030. Polymer films of the present invention can also include a hardcoat and/or and antifog layer, as are known in the art.

### Polymer Sheet

As used herein, a “polymer sheet” means any polymer composition formed by any suitable method into a thin layer that is suitable alone, or in stacks of more than one layer, for use as a polymer stack that provides adequate penetration resistance and glass retention properties to laminated glazing panels. Plasticized poly(vinyl butyral) is most commonly used to form polymer sheets. A polymer stack in combination with a polymer film is a “polymeric laminate” that can be used as the composite polymeric component in a bilayer.

The polymer sheet can comprise any suitable polymer, and, in a preferred embodiment, the polymer sheet comprises poly(vinyl butyral). In any of the embodiments of the present invention given herein that comprise poly(vinyl butyral) as the polymeric component of the polymer sheet, another embodiment is included in which the polymer component consists of or consists essentially of poly(vinyl butyral). In these embodiments, any of the variations in additives disclosed herein can be used with the polymer sheet having a polymer consisting of or consisting essentially of poly(vinyl butyral).

In one embodiment, the polymer sheet comprises a polymer based on partially acetalized poly(vinyl alcohol)s. In another embodiment, the polymer sheet comprises a polymer selected from the group consisting of poly(vinyl butyral), polyurethane, poly(vinyl chloride), poly(ethylene-co-vinyl acetate), partially neutralized ethylene/(meth)acrylic copolymers, ionomers, combinations thereof, and the like. In further embodiments the polymer sheet comprises poly(vinyl butyral) and one or more other polymers.

Other polymers having a suitable glass transition temperature can also be used. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful as components in polymer sheets.

For embodiments comprising poly(vinyl butyral), the poly(vinyl butyral) can be produced by known acetalization processes that involve reacting poly(vinyl alcohol) with butyraldehyde in the presence of an acid catalyst, followed by neutralization of the catalyst, separation, stabilization, and drying of the resin.

As used herein, “resin” refers to the polymeric (for example poly(vinyl butyral)) component that is removed from the mixture that results from the acid catalysis and subsequent neutralization of the polymeric precursors. Resin will generally have other components in addition to the polymer, for example poly(vinyl butyral), such as acetates, salts, and alcohols.

Details of suitable processes for making poly(vinyl butyral) resin are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, 3rd edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.

In various embodiments, the polymer sheet can comprise less than 15 wt. % residual ester groups, 13 wt. %, 11 wt. %, 9 wt. %, 7 wt. %, 5 wt. %, or less than 3 wt. % residual ester groups calculated as polyvinyl acetate, with the balance being an acetal, preferably butyraldehyde acetal, but optionally including other acetal groups in a minor amount, e.g., a 2-ethyl hexanal group (see, for example, U.S. Pat. No. 5,137,954).

In various embodiments, the polymer sheet comprises poly(vinyl butyral) having a molecular weight greater than 30,000, 40,000, 50,000, 55,000, 60,000, 65,000, 70,000, 120,000, 250,000, or 350,000 grams per mole (g/mole or Daltons). Small quantities of a dialdehyde or trialdehyde can also be added during the acetalization step to increase molecular weight to greater than 350,000 Daltons (see, for example, U.S. Pat. Nos. 4,874,814; 4,814,529; and 4,654,179). As used herein, the term “molecular weight” means the weight average molecular weight.

Any suitable plasticizers can be added to the polymer resins of the present invention in order to form the polymer sheets. Plasticizers used in the polymer sheets of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, mixtures of phosphates and adipates such as those disclosed in U.S. Pat. No. 3,841,890 and adipates such as those disclosed in U.S. Pat. No. 4,144,217, and mixtures and combinations of the foregoing. Other plasticizers that can be used are mixed adipates made from C4 to C9 alkyl alcohols and cyclo C4 to C10 alcohols, as disclosed in U.S. Pat. No. 5,013,779, and C₆ to C₈ adipate esters, such as hexyl adipate. In preferred embodiments, the plasticizer is triethylene glycol di-(2-ethylhexanoate).

Polymer sheets can comprise 20 to 60, 25 to 60, 20 to 80, 10 to 70, or 5 to 100 parts plasticizer phr. Of course other quantities can be used as is appropriate for the particular application. In some embodiments, the plasticizer has a hydrocarbon segment of fewer than 20, fewer than 15, fewer than 12, or fewer than 10 carbon atoms.

Adhesion control agents (ACAs) can also be included in the polymer sheets of the present invention to impart the desired adhesiveness. Any of the ACAs disclosed in U.S. Pat. No. 5,728,472 can be used. Additionally, residual sodium acetate and/or potassium acetate can be adjusted by varying the amount of the associated hydroxide used in acid neutralization. In various embodiments, polymer sheets of the present invention comprise, in addition to sodium acetate and/or potassium acetate, magnesium bis(2-ethyl butyrate) (chemical abstracts number 79992-76-0). The magnesium salt can be included in an amount effective to control adhesion of the polymer sheet to glass.

Additives may be incorporated into the polymer sheet to enhance its performance in a final product. Such additives include, but are not limited to, plasticizers, dyes, pigments, stabilizers (e.g., ultraviolet stabilizers), antioxidants, flame retardants, other IR absorbers, UV absorbers, anti-block agents, combinations of the foregoing additives, and the like, as are known in the art.

In addition to cesium tungsten oxide, other agents that selectively absorb light in the visible or near infrared spectrum can be added to any of the appropriate polymer sheets or other layers. Agents that can be used include dyes and pigments such as indium tin oxide, antimony tin oxide, or lanthanum hexaboride (LaB₆).

One exemplary method of forming a poly(vinyl butyral) layer comprises extruding molten poly(vinyl butyral) comprising resin, plasticizer, and additives (the “melt”), and then forcing the melt through a sheet die (for example, a die having an opening that is substantially greater in one dimension than in a perpendicular dimension).

Another exemplary method of forming a poly(vinyl butyral) layer comprises casting a melt from a die onto a roller, solidifying the melt, and subsequently removing the solidified melt as a sheet. In either embodiment, the surface texture at either or both sides of the layer may be controlled by adjusting the surfaces of the die opening or by providing texture at the roller surface. Other techniques for controlling the layer texture include varying parameters of the materials (for example, the water content of the resin and/or the plasticizer, the melt temperature, molecular weight distribution of the poly(vinyl butyral), or combinations of the foregoing parameters). Furthermore, the layer can be configured to include spaced projections that define a temporary surface irregularity to facilitate the de-airing of the layer during lamination processes after which the elevated temperatures and pressures of the laminating process cause the projections to melt into the layer, thereby resulting in a smooth finish.

In various embodiments, the polymer stacks of the present invention can have total thicknesses of 0.1 to 3.0 millimeters, 0.2 to 2.0 millimeters, 0.25 to 1.75 millimeters, and 0.3 to 1.5 millimeters, although other thicknesses, including greater thicknesses, are within the scope of the present invention. The individual polymer sheets of a multiple layer polymer stack can have, for example, approximately equal thicknesses that, when added together, result in the total thickness ranges given above. Of course, in other embodiments, the thicknesses of the layers can be different, and can still add to the total thicknesses given above.

Bilayers of the present invention can be formed through any suitable process. In various embodiments, a bilayer is formed by stacking and then laminating the following layers: glass//polymer sheet//polymer film//glass. Lamination of this stack can be performed by any appropriate laminating process in the art, including known autoclave procedures. After lamination, the pane of glass that is in contact with the polymer film can be peeled off of the polymer film, leaving a single pane of glass having a polymer sheet disposed thereon with a polymer film disposed on the polymer sheet. Any multiple layer polymer stack of the present invention can be substituted for the polymer sheet in these methods (i.e. glass//polymer stack//polymer film//glass).

The present invention also includes methods of manufacturing any of the bilayers of the present invention comprising using a vacuum non-autoclave process. In various embodiments of the present invention, a bilayer of the present invention is manufactured using a vacuum deairing non-autoclave process embodiment described in U.S. Pat. No. 5,536,347. In various other embodiments, a nip roll non-autoclave process embodiment described in published U.S. application US 2003/0148114 A1 is used.

The present invention also includes methods of making a bilayer, comprising disposing a polymer stack of the present invention between a rigid substrate and a polymer film, and laminating the construct to form a bilayer.

The present invention also includes glazing panels comprising any of the bilayers of the present invention.

The following paragraphs describe various techniques that can be used to measure the characteristics of the polymer sheet.

The clarity of a polymer sheet can be determined by measuring the haze value, which is a quantification of the light scattered by a sample in contrast to the incident light. The percent haze can be measured according to the following technique. An apparatus for measuring the amount of haze, a Hazemeter, Model D25, which is available from Hunter Associates (Reston, Va.), can be used in accordance with ASTM D1003-61 (Re-approved 1977)-Procedure A, using Illuminant C, at an observer angle of 2 degrees. In various embodiments of the present invention, percent haze is less than 5%, less than 3%, and less than 1%.

The visible transmittance can be quantified using a UV-Vis-NIR spectrophotometer such as the Lambda 900 made by Perkin Elmer Corp. by methods described in international standard ISO 10526-1999.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17.8° C. (0° F.) and manually pummeled with a hammer to break the glass. All broken glass that is not adhered to the poly(vinyl butyral) layer is then removed, and the amount of glass left adhered to the poly(vinyl butyral) layer is visually compared with a set of standards. The standards correspond to a scale in which varying degrees of glass remain adhered to the poly(vinyl butyral) layer. In particular, at a pummel standard of zero, no glass is left adhered to the poly(vinyl butyral) layer. At a pummel standard of 10, 100% of the glass remains adhered to the poly(vinyl butyral) layer. Poly(vinyl butyral) layers of the present invention can have, for example, a pummel value of between 3 and 10.

### EXAMPLE 1

Two polymer sheets comprising 38 parts per hundred resin plasticizer, 0.5 parts per hundred resin Tinuvin 326 stabilizer (2-tert-Butyl-6-(5-chloro-benzotriazol-2-yl)-4-methyl-phenol—available from Ciba Specialty Chemicals), and 0.3 weight percent cesium tungsten oxide are formed. The sheets are laminated between two glass panes or 15 a glass pane and a layer of poly(ethylene terephthalate) (a bilayer) and tested over time for visible transmission in a Weatherometer. A control bilayer having no cesium tungsten oxide is also tested. Results are shown in the table, below:

| | Time | | | |
|---|---|---|---|---|
| Laminate Construct | Zero | 500 hours | 1000 hours | 2000 hours |
| Glass-Glass Laminate | 62.1 | 53.9 | Test stopped | Test stopped |
| Visible Transmission | | | @ 500 hours | @ 500 hours |
| Percentage (0.3 weight | | | | |
| percent cesium | | | | |
| tungsten oxide) | | | | |
| Glass-poly(ethylene | 63.0 | 62.8 | 62.6 | 62.2 |
| terephthalate) Bilayer | | | | |
| Visible Transmission | | | | |
| Percentage (0.3 weight | | | | |
| percent cesium | | | | |
| tungsten oxide) | | | | |
| Glass-poly(ethylene | 88.7 | 88.5 | 88.4 | 88.3 |
| terephthalate) Bilayer | | | | |
| Visible Transmission | | | | |
| Percentage (0.0 weight | | | | |
| percent cesium | | | | |
| tungsten oxide) | | | | |

The weatherometer is a model Xenon Arc Atlas Ci65 (Atlas Material Testing Technology LLC, Chicago, Ill.) operated with the following settings:

| Parameter | Setting |
|---|---|
| Irradiance | 0.55 W/m² |
| Black Panel Temp | 70° C. |
| Water spray | None |
| Filters - inner | Quartz |
| Filters - outer | Borosilicate (Type S) |

Results show good bilayer stability over time.

By virtue of the present invention, it is now possible to provide bilayers having improved edge stability character for use as glazing panels, such as laminated glass panels for windshields and architectural windows.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a polymer sheet can be formed comprising any of the plasticizer contents as well as various residual hydroxyl contents to form many permutations that are within the scope of the present invention but that would be exceedingly cumbersome to list.

Any figure reference numbers given within the abstract or any claims are for illustrative purposes only and should not be construed to limit the claimed invention to any one particular embodiment shown in any figure.

Figures are not drawn to scale unless otherwise indicated.

Each reference, including journal articles, patents, applications, and books, referred to herein is hereby incorporated by reference in its entirety.

We claim:

1. A bilayer glazing panel, comprising:
a layer of glass substrate;
a poly(ethylene)terephthalate polymer film, and
a polymer stack disposed between said layer of glass substrate and said poly(ethylene)terephthalate polymer film, wherein said polymer stack comprises a poly(vinyl butyral) sheet that comprises 0.05 to 0.5 weight percent cesium tungsten oxide wherein said cesium tungsten oxide is Cs_{0.33}WO₃.

2. The bilayer glazing panel of claim 1, wherein said bilayer glazing panel comprises cesium tungsten oxide in an amount effective to prevent transmission of at least 75% of infrared radiation in the 800 nanometer to 1,000 nanometer range.

3. The bilayer glazing panel of claim 1, wherein said bilayer glazing panel comprises cesium tungsten oxide in an amount effective to prevent transmission of at least 95% of infrared radiation in the 800 nanometer to 1,000 nanometer range.

4. The bilayer glazing panel of claim 1, wherein said polymer stack comprises a second polymer film disposed between said polymer sheet and a second polymer sheet.

5. The bilayer glazing panel of claim 1, wherein said cesium tungsten oxide is disposed in said polymer stack.

6. The bilayer glazing panel of claim 1, wherein said polymer film comprises 0.05 to 0.5 weight percent cesium tungsten oxide.

7. The bilayer glazing panel of claim 1, wherein said polymer film comprises 0.1 to 0.3 weight percent cesium tungsten oxide.

8. A bilayer glazing panel, comprising:
a layer of glass substrate;
a poly(ethylene)terephthalate polymer film, and
a polymer stack disposed between said layer of glass substrate and said poly(ethylene)terephthalate polymer film, wherein said polymer stack comprises a poly(vinyl butyral) sheet that comprises 0.1 to 0.3 weight percent cesium tungsten oxide wherein said cesium tungsten oxide is Cs_{0.33}WO₃.

9. The bilayer glazing panel of claim 8, wherein said bilayer glazing panel comprises cesium tungsten oxide in an amount effective to prevent transmission of at least 75% of infrared radiation in the 800 nanometer to 1,000 nanometer range.

10. The bilayer glazing panel of claim 8, wherein said bilayer glazing panel comprises cesium tungsten oxide in an amount effective to prevent transmission of at least 95% of infrared radiation in the 800 nanometer to 1,000 nanometer range.

11. The bilayer glazing panel of claim 8, wherein said polymer stack comprises a second polymer film disposed between said polymer sheet and a second polymer sheet.

12. A bilayer glazing panel, comprising:
a layer of glass substrate;
a poly(ethylene)terephthalate polymer film, and
a polymer stack disposed between said rigid substrate and said polymer film, wherein said polymer stack comprises a poly(vinyl) butyral) sheet and wherein the panel comprises 0.05 to 0.5 weight percent cesium tungsten oxide.

13. The bilayer glazing panel of claim 12, wherein said bilayer glazing panel comprises cesium tungsten oxide in an amount effective to prevent transmission of at least 75% of infrared radiation in the 800 nanometer to 1,000 nanometer range.

14. The bilayer glazing panel of claim 12, wherein said bilayer glazing panel comprises cesium tungsten oxide in an amount effective to prevent transmission of at least 95% of infrared radiation in the 800 nanometer to 1,000 nanometer range.

15. The panel of claim 12, wherein the cesium tungsten oxide is disposed in said polymer film or in the poly(vinyl butyral) sheet.

16. The panel of claim 12, wherein said cesium tungsten oxide is Cs_{0.33}WO₃.

17. The panel of claim 12, wherein the polymer film comprises 0.1 to 0.3 weight percent cesium tungsten oxide.
